(19) United States
(12) Patent Application Publication
(10) Pub. No.: US 2012/0022411 A1
(43) Pub. Date: Jan. 26, 2012

(54) Skin-cover Structure

(75) Inventor: Kuei-Huang Wu, Dasi Township (TW)

(73) Assignees: TOP-BOUND ENTERPRISE CO. LTD., Taipei County (TW); Hong-So Kao, Taipei (TW)

(21) Appl. No.: 12/842,120

(22) Filed: Jul. 23, 2010

(51) Int. Cl. A61H 1/00

(52) U.S. Cl. 601/15

(57) ABSTRACT

The present invention discloses a skin-cover structure comprising: a heating layer comprising a sheet of conductive rubber and at least one conductive and low-impedance material, wherein the sheet of conductive rubber can produce heat energy; a first insulating layer and a second insulating layer being disposed on the two surfaces of the heating layer respectively; at least one vibration module being disposed on the surface of the first insulating layer and able to produce vibration with specific strength when receiving electricity; and at least one electrode module being disposed on the surface of the second insulating layer and able to produce electric shock with specific strength when receiving electricity.

### BACKGROUND OF THE INVENTION

1. Field of the Invention

The present invention relates to a skin-cover structure, and more particularly to a skin-cover structure having the function of hot compress, massage, electric shock and infrared radiation simultaneously.

2. Description of the Prior Art

A conventional skin-cover sheet usually contains one function merely, such as hot compress, electric shock, massage or moisturizing. Thus, if a user wants to achieve one of the above purposes, a specific skin-cover sheet has to be chosen. However, if the user desires to get several purposes of skin care, several kinds of skin-cover sheet have to be used in turn and it takes a lot of time in the skin care.

Therefore, if a multi-function skin-cover sheet can be provided and can achieve several purposes of skin care at the same time, it can save much time in skin care.

Furthermore, a conventional electric heating piece with the function of heat generating or heat preservation as shown in FIG. 1 is made of insulated materials A1 and A2 and a metal material A3, and the metal material A3 is disposed between the insulated materials A1 and A2 with a bended arrangement. When the metal material A3 is conducted with current, heat is generated and dispersed throughout the whole electric heating piece. However, owing to the bended end of the metal material A3 may easily produce point discharge which makes the temperature of the bended end is higher and causes the temperature of the electric heating piece uneven, the use of the electric heating piece is not ideal.

Therefore, it is necessary to provide a multi-function skin-cover sheet which can generate heat with even temperature and exert a maximum effect of the hot compress function.

### SUMMARY OF THE INVENTION

In view of the above shortcomings of the prior art, the inventor of the present invention resorted to past experience, imagination, and creativity, performed experiments and researches repeatedly, and eventually devised the present invention, a skin-cover structure.

The major objective of the present invention is to provide the skin-cover structure, which can provide the functions of hot compress, massage, electric shock and infrared radiation at the same time, and a user can obtain several effects of skin care in a short period.

Another objective of the present invention is to provide the skin-cover structure, which provides the heating function with even temperature by employing a heating layer so as to increase the effect of hot compress.

Further objective of the present invention is to provide the skin-cover structure, which employs two cover layers disposed on the two surface of the skin-cover structure and provides each component with the protective effect so as to prevent the components from damage.

Consequently, the present invention provides a skin-cover structure comprising: a heating layer comprising a sheet of conductive rubber and at least one conductive and low-impedance material, wherein the conductive and low-impedance material is embedded in the sheet of conductive rubber, and the conductive and low-impedance material being able to transmit current to the sheet of conductive rubber so that the sheet of conductive rubber can produce heat energy; a first insulating layer and a second insulating layer being disposed on the two surfaces of the heating layer respectively; at least one vibration module being disposed on the surface of the first insulating layer and able to produce vibration with specific strength when receiving electricity, wherein the vibration module and the heating layer are insulated by the first insulating layer so as to avoid the interference of the current of the vibration module and the heating layer; and at least one electrode module being disposed on the surface of the second insulating layer and able to produce electric shock with specific strength when receiving electricity, wherein the electrode module and the heating layer are insulated by the second insulating layer so as to avoid the interference of the current of the electrode module and the heating layer.

Furthermore, the present invention provides another skin-cover structure comprising: a heating layer comprising a sheet of conductive rubber and at least one conductive and low-impedance material, wherein the conductive and low-impedance material is embedded in the sheet of conductive rubber, and the conductive and low-impedance material being able to transmit current to the sheet of conductive rubber so that the sheet of conductive rubber can produce heat energy; a first insulating layer and a second insulating layer being disposed on the two surfaces of the heating layer respectively; a first cover layer being disposed on the surface of the first insulating layer and providing the first insulating layer with a protective effect; at least one vibration module being disposed between the first insulating layer and the first cover layer and able to produce vibration with specific strength when receiving electricity, wherein the vibration module and the heating layer are insulated by the first insulating layer so as to avoid the interference of the current of the vibration module and the heating layer; a second cover layer being disposed on the surface of the second insulating layer and providing the second insulating layer with a protective effect; and at least one electrode module being disposed on the surface of the second cover layer and able to produce electric shock with specific strength when receiving electricity, wherein the electrode module and the heating layer are insulated by the second insulating layer and the second cover layer so as to avoid the interference of the current of the electrode module and the heating layer.

### BRIEF DESCRIPTION OF THE DRAWINGS

For a complete understanding of the aspects, structures and techniques of the invention, reference should be made to the following detailed description and accompanying drawings wherein:

FIG. 1 is a perspective diagram of a conventional electric heating piece;

FIG. 2 is a perspective assembly diagram of a skin-cover structure according to a first preferred embodiment of the present invention;

FIG. 3 is a perspective assembly diagram of the skin-cover structure according to the first preferred embodiment of the present invention viewed from another angle;

FIG. 4 is an exploded diagram of the skin-cover structure according to the first preferred embodiment of the present invention;

FIG. 5 is a perspective diagram of the skin-cover structure connected with a control device according to the first preferred embodiment of the present invention; and

FIG. 6 is an exploded diagram of the skin-cover structure according to a second preferred embodiment of the present invention.

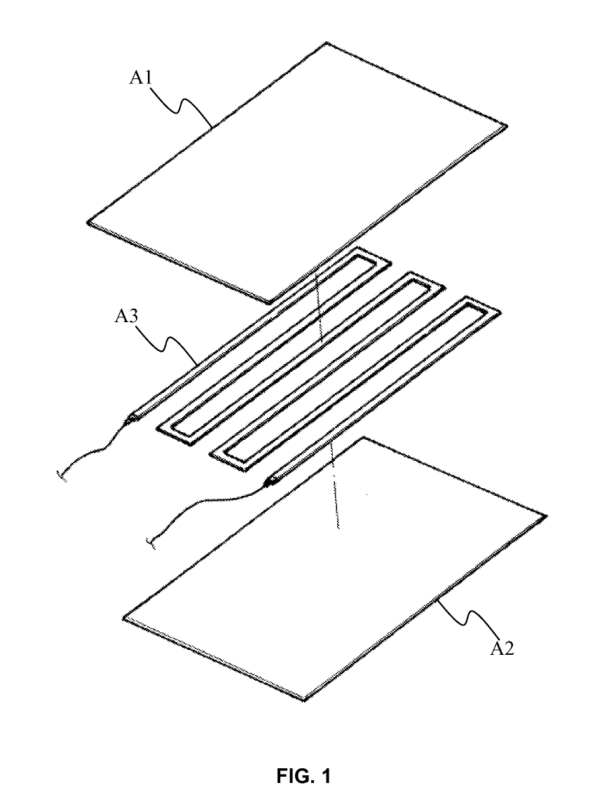

### DETAILED DESCRIPTION OF THE PREFERRED EMBODIMENTS

Hereinafter, the skin-cover structure according to a first preferred embodiment and a second preferred embodiment of the present invention will be described in detail for illustrating the structural features and principles of the present invention. In order to make the following first preferred embodiment and the second preferred embodiment more straightforward, a mask is as a representative and used for detailed introducing the skin-cover structure of the present invention. However, the skin-cover structure of the present invention is not limited in the mask, and all the skin-cover sheets which can be used in skin care are included in the range of the present invention.

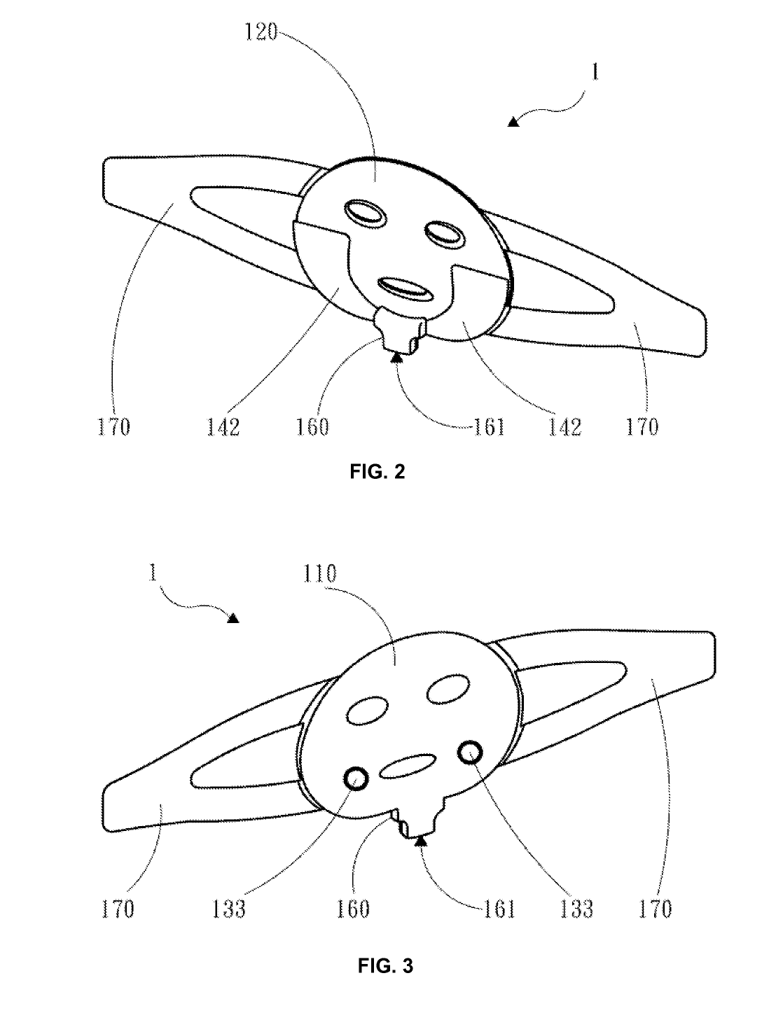

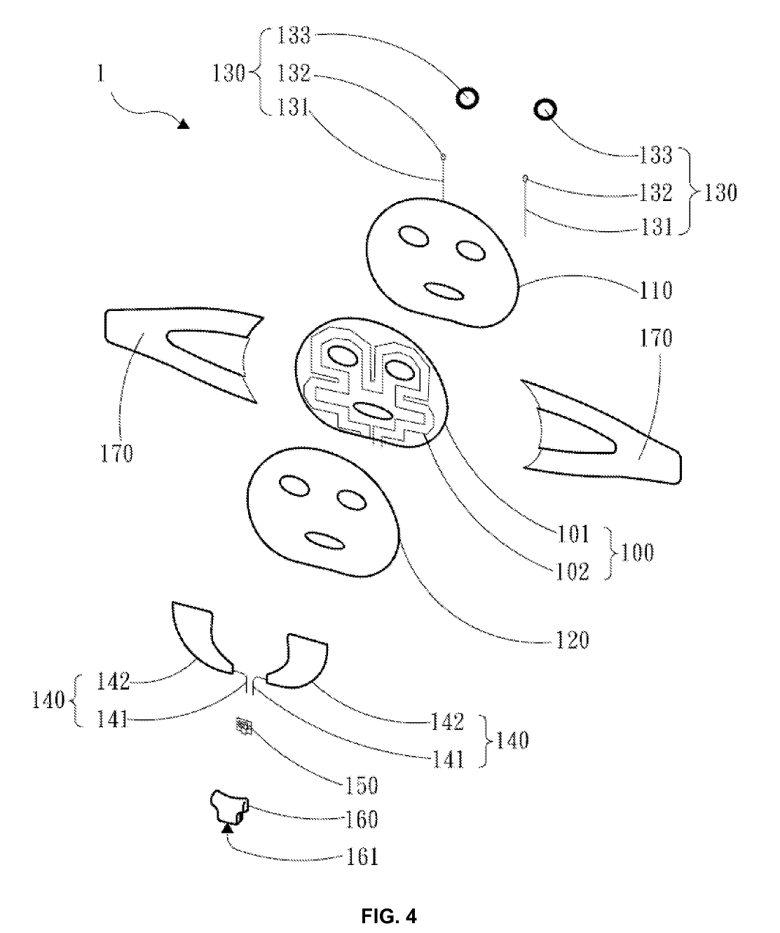

Referring to FIG. 2, FIG. 3 and FIG. 4, FIG. 2 is a perspective assembly diagram of the skin-cover structure according to the first preferred embodiment of the present invention, FIG. 3 is a perspective assembly diagram of the skin-cover structure according to the first preferred embodiment of the present invention viewed from another angle, FIG. 4 is an exploded diagram of the skin-cover structure according to the first preferred embodiment of the present invention. The skin-cover structure 1 includes a heating layer 100, a first insulating layer 110, a second insulating layer 120, two vibration modules 130, two electrode modules 140, a printed circuit board 150, a slot cover 160, and tow buckle elements 170.

The heating layer 100 includes a sheet of conductive rubber 101 and a conductive and low-impedance material 102, wherein the conductive and low-impedance material 102 is embedded in the sheet of conductive rubber 101. The conductive and low-impedance material 102 can transmit current to the sheet of conductive rubber 101, and then the sheet of conductive rubber 101 can produce heat energy. The conductive rubber in the present invention refers any rubber which can conduct electricity, for example, metal powder or carbon powder is mixed in a rubber so as to make the rubber have conductive property.

The first insulating layer 110 and the second insulating layer 120 are disposed on the two surfaces of the heating layer 100 respectively and provide the effect of insulation. The first insulating layer 110 and the second insulating layer 120 can be made of silica gel.

The two vibration modules 130 are disposed on the surface of the first insulating layer 110 and can produce vibration with specific strength when receiving electricity. The two vibration modules 130 and the heating layer 100 are insulated by the first insulating layer 110 so as to avoid the interference of the current of the two vibration module 130 and the heating layer 100. The two vibration modules 130 respectively include a power line 131, a vibration unit 132 and a protective cover 133. The vibration unit 132 is connected with the power line 131 and can produce vibration after receiving electricity. The protective cover 133 covers the vibration unit 132, and it can prevent the vibration unit 132 from being hit and getting damage.

The two electrode modules 140 are disposed on the surface of the second insulating layer 120 and can produce electric shock with specific strength when receiving electricity. The two electrode modules 140 and the heating layer 100 are insulated by the second insulating layer 120 so as to avoid the interference of the current of the two electrode modules 140 and the heating layer 100. The two electrode modules 140 respectively include a power line 141 and an electrode 142. The electrode 142 is connected with the power line 142, and the electrode 142 can receive electricity and produce the effect of electric shock.

The printed circuit board 150 is electrically connected with the conductive and low-impedance material 102, the two vibration modules 130 and the two electrode module 140, and the printed circuit board 150 can control the transmission of the current and the functional switch of the conductive and low-impedance material 102, the two vibration modules 130 and the two electrode modules 140.

The slot cover 160 is disposed on the second insulating layer 120 and has an opening 161. The printed circuit board 150 is disposed in the slot cover 160. A control line can be inserted into the slot cover 160 through the opening 161 and electrically connected with the printed circuit board 150. The control line can control the function of the heating layer 100, the two vibration modules 130 and the two electrode modules 140 through the printed circuit board 150.

The two buckle elements 170 are disposed on the two opposite sides of the skin-cover structure 1 respectively. The two buckle elements 170 can be hung on the two ears of a user and stuck to each other, and then the skin-cover structure 1 can be set on the face firmly without loosing.

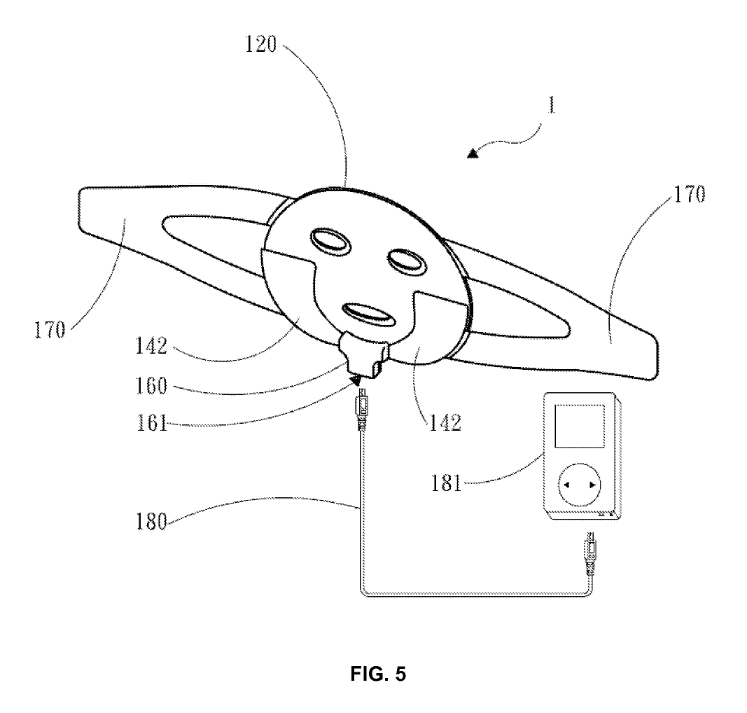

Referring to FIG. 5, a perspective diagram of the skin-cover structure connected with a control device according to the first preferred embodiment of the present invention is illustrated. The skin-cover structure 1 of the present invention can be connected with the control device 181 by the control line 180, wherein one end of the control line 180 is inserted into the opening 161 of the slot cover 160 and electrically connected with the printed circuit board 150, and another end of the control line 180 is connected with the control device 181. By using the control device 181, the user can control all the functions of the skin-cover structure 1, such as power switch, heating temperature, vibration strength, and electric shock strength, thus the user can adjust all the effects according to the needs.

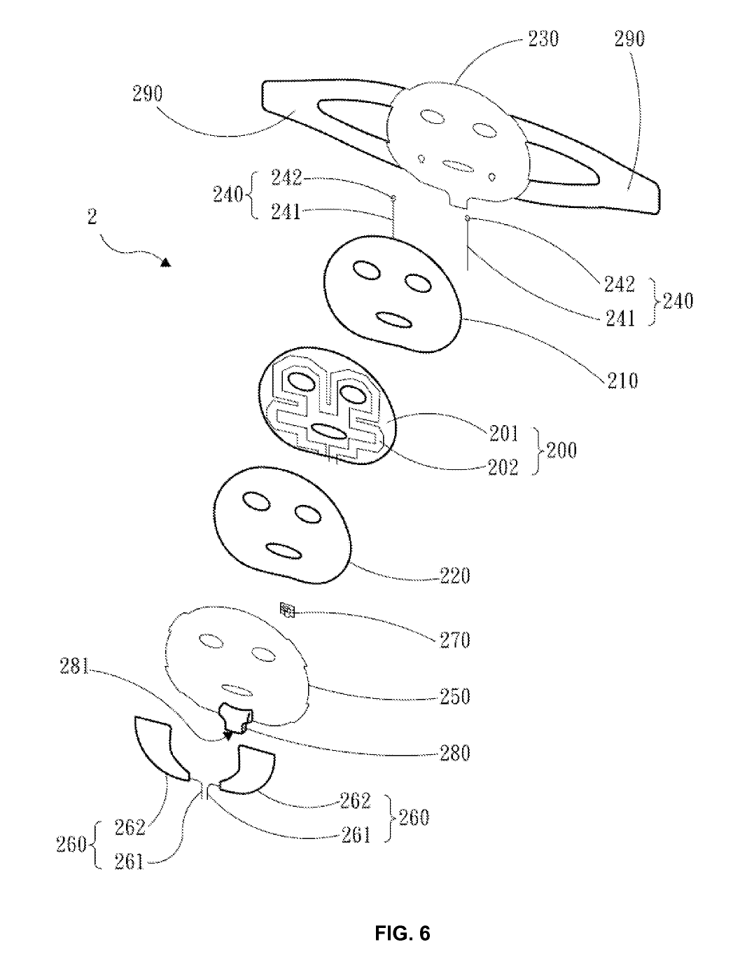

Referring to FIG. 6, an exploded diagram of the skin-cover structure according to a second preferred embodiment of the present invention is illustrated. The skin-cover structure 2 includes a heating layer 200, a first insulating layer 210, a second insulating layer 220, a first cover layer 230, two vibration modules 240, a second cover layer 250, two electrode modules 260, a printed circuit board 270, a slot cover 280, and two buckle elements 290.

The heating layer 200 includes a sheet of conductive rubber 201 and a conductive and low-impedance material 202, wherein the conductive and low-impedance material 202 is embedded in the sheet of conductive rubber 201. The conductive and low-impedance material 202 can transmit current to the sheet of conductive rubber 201, and then the sheet of conductive rubber 201 can produce heat energy. The conductive rubber in the present invention refers any rubber which can conduct electricity, for example, metal powder or carbon powder is mixed in a rubber so as to make the rubber have conductive property.

The first insulating layer 210 and the second insulating layer 220 are disposed on the two surfaces of the heating layer 200 respectively and provide the effect of insulation. The first insulating layer 210 and the second insulating layer 220 can be made of silica gel.

The first cover layer 230 is disposed on the surface of the first insulating layer 210 and can provide the first insulating layer 210 with a protective effect.

The two vibration modules 240 are disposed between the first insulating layer 210 and the first cover layer 230, and the two vibration modules 240 can produce vibration with specific strength when receiving electricity. The two vibration modules 240 and the heating layer 200 are insulated by the first insulating layer 210 so as to avoid the interference of the current of the two vibration module 240 and the heating layer 200. The two vibration modules 240 respectively include a power line 241 and a vibration unit 242. The vibration unit 242 is connected with the power line 241 and can produce vibration after receiving electricity.

The second cover layer 250 is disposed on the surface of the second insulating layer 220, and can provide the second insulating layer 220 with a protective effect.

The two electrode modules 260 are disposed on the surface of the second cover layer 250 and can produce electric shock with specific strength when receiving electricity. The two electrode modules 260 and the heating layer 200 are insulated by the second insulating layer 220 and the second cover layer 250 so as to avoid the interference of the current of the two electrode modules 260 and the heating layer 200. The two electrode modules 260 respectively include a power line 261 and an electrode 262. The electrode 262 is connected with the power line 262, and the electrode 262 can receive electricity and produce the effect of electric shock.

The printed circuit board 270 is electrically connected with the conductive and low-impedance material 202, the two vibration modules 240 and the two electrode module 260, and the printed circuit board 270 can control the transmission of the current and the functional switch of the conductive and low-impedance material 202, the two vibration modules 240 and the two electrode modules 260.

The slot cover 280 is disposed on the second cover layer 250 and has an opening 281. The printed circuit board 270 is disposed in the slot cover 280. A control line can be inserted into the slot cover 280 through the opening 281 and electrically connected with the printed circuit board 270. The control line can control the function of the heating layer 200, the two vibration modules 240 and the two electrode modules 260 through the printed circuit board 270.

The two buckle elements 290 are disposed on the two opposite sides of the skin-cover structure 2 respectively. The two buckle elements 290 can be hung on the two ears of a user and stuck to each other, and then the skin-cover structure 2 can be set on the face firmly without loosing.

By the detailed description of the present invention, the following advantages of the present invention can be derived:

The present invention provides the functions of hot compress, massage, electric shock and infrared radiation at the same time, and a user can obtain several effects of skin care in a short period.

The present invention provides the heating function with even temperature by employing a heating layer so as to increase the effect of hot compress.

The present invention employs two cover layers disposed on the two surface of the skin-cover structure and provides each component with the protective effect so as to prevent the components from damage.

It should be understood that the embodiments of the present invention described herein are merely illustrative of the technical concepts and features of the present invention and are not meant to limit the scope of the invention. Those skilled in the art, after reading the present disclosure, will know how to practice the invention. Various variations or modifications can be made without departing from the spirit of the invention. All such equivalent variations and modifications are intended to be included within the scope of the invention.

As a result of continued thinking about the invention and modifications, the inventors finally work out the designs of the present invention that has many advantages as described above. The present invention meets the requirements for an invention patent, and the application for a patent is duly filed accordingly. It is expected that the invention could be examined at an early date and granted so as to protect the rights of the inventors.

What is claimed is:

1. A skin-cover structure comprising:
a heating layer comprising a sheet of conductive rubber and at least one conductive and low-impedance material, wherein the conductive and low-impedance material is embedded in the sheet of conductive rubber, and the conductive and low-impedance material being able to transmit current to the sheet of conductive rubber so that the sheet of conductive rubber can produce heat energy;
a first insulating layer and a second insulating layer being disposed on the two surfaces of the heating layer respectively;
at least one vibration module being disposed on the surface of the first insulating layer and able to produce vibration with specific strength, wherein the vibration module and the heating layer are insulated by the first insulating layer so as to avoid the interference of the current of the vibration module and the heating layer; and
at least one electrode module being disposed on the surface of the second insulating layer and able to produce electric shock with specific strength, wherein the electrode module and the heating layer are insulated by the second insulating layer so as to avoid the interference of the current of the electrode module and the heating layer.

2. The skin-cover structure according to claim 1, wherein the vibration module comprises:
a power line;
a vibration unit being connected with the power line and able to produce vibration; and
a protective cover covering the vibration unit and preventing the vibration unit from being hit and getting damage.

3. The skin-cover structure according to claim 1, wherein the electrode module comprises a power line and an electrode, and the electrode being connected with the power line for receiving electricity so as to produce the effect of electric shock.

4. The skin-cover structure according to claim 1, further comprising a printed circuit board electrically connected with the conductive and low-impedance material, the vibration module and the electrode module, wherein the printed circuit board can control the transmission of the current and the functional switch of the conductive and low-impedance material, the vibration module and the electrode module.

5. The skin-cover structure according to claim 4, further comprising a slot cover disposed on the second insulating layer and having an opening, and the printed circuit board being disposed in the slot cover, wherein a control line can insert into the slot cover through the opening and electrically connect with the printed circuit board, and the control line being able to control the function of the heating layer, the vibration module and the electrode module through the printed circuit board.

6. A skin-cover structure comprising:
a heating layer comprising a sheet of conductive rubber and at least one conductive and low-impedance material, wherein the conductive and low-impedance material is embedded in the sheet of conductive rubber, and the conductive and low-impedance material being able to transmit current to the sheet of conductive rubber so that the sheet of conductive rubber can produce heat energy;
a first insulating layer and a second insulating layer being disposed on the two surfaces of the heating layer respectively;
a first cover layer being disposed on the surface of the first insulating layer and providing the first insulating layer with a protective effect;
at least one vibration module being disposed between the first insulating layer and the first cover layer and able to produce vibration with specific strength, wherein the vibration module and the heating layer are insulated by the first insulating layer so as to avoid the interference of the current of the vibration module and the heating layer;
a second cover layer being disposed on the surface of the second insulating layer and providing the second insulating layer with a protective effect; and
at least one electrode module being disposed on the surface of the second cover layer and able to produce electric shock with specific strength, wherein the electrode module and the heating layer are insulated by the second insulating layer and the second cover layer so as to avoid the interference of the current of the electrode module and the heating layer.

7. The skin-cover structure according to claim 6, wherein the vibration module comprises:
a power line; and
a vibration unit being connected with the power line and able to produce vibration.

8. The skin-cover structure according to claim 6, wherein the electrode module comprises a power line and an electrode, and the electrode being connected with the power line for receiving electricity so as to produce the effect of electric shock.

9. The skin-cover structure according to claim 6, further comprising a printed circuit board electrically connected with the conductive and low-impedance material, the vibration module and the electrode module, wherein the printed circuit board can control the transmission of the current and the functional switch of the conductive and low-impedance material, the vibration module and the electrode module.

10. The skin-cover structure according to claim 9, further comprising a slot cover disposed on the second cover layer and having an opening, and the printed circuit board being disposed in the slot cover, wherein a control line can insert into the slot cover through the opening and electrically connected with the printed circuit board, and the control line being able to control the function of the heating layer, the vibration module and the electrode module through the printed circuit board.
